(19) United States
(12) Patent Application Publication
(10) Pub. No.: US 2010/0101510 A1
(43) Pub. Date: Apr. 29, 2010

(54) WATER HEATERS WITH SEALED DOOR ASSEMBLY

(76) Inventors: Emadeddin Y. Tanbour, Johnson City, TN (US); Rodney Ray Syler, Franklin, TN (US); Mark Allan Murphy, Nashville, TN (US); Marcus E. McAnally, Nashville, TN (US)

Correspondence Address: MICHAEL BEST & FRIEDRICH LLP, 100 E WISCONSIN AVENUE, Suite 3300, MILWAUKEE, WI, 53202, US

(21) Appl. No.: 12/260,224

(22) Filed: Oct. 29, 2008

(51) Int. Cl. F24H 9/02; F24H 1/00; B23P 19/04

(52) U.S. Cl. 122/19.2; 122/17.1; 29/700

(57) ABSTRACT

A water heater door assembly includes a base plate sized and shaped to substantially sealingly cover an access opening in a water heater combustion chamber and having at least one opening through which a fuel supply line extends at least partly between a burner in the combustion chamber and a fuel control valve, and a seal positioned at least partly within the opening and having a through hole that is sized and shaped to receive the fuel supply line, the seal comprising a plurality of complementary deformed seal pieces sealed together, to the opening and to the fuel supply line by a deforming force.

### TECHNICAL FIELD

This disclosure relates to water heaters, particularly to water heaters that have door assemblies, such as those for water heater combustion chambers.

### BACKGROUND

Gas fired water heaters traditionally have a water container placed above or adjacent to a combustion chamber and burner assembly. The burner assembly is controlled by a gas control valve which may be responsive to user input, such as a temperature setting. The burner assembly may have a main gas line extending from the gas control valve, through the combustion chamber wall or door, and to the burner. Gas lines have been constructed using various configurations and materials. By way of example, rigid tubing has been used where possible and in some cases threaded fittings are used to connect the rigid tubing to flexible tubing.

It could be beneficial to provide a sealed door assembly that is simple, compact, durable, tamper-resistant and economical to construct.

### SUMMARY

We provide a water heater door assembly comprising a base plate sized and shaped to substantially sealingly cover an access opening in a water heater combustion chamber and having at least one opening through which a fuel supply line extends at least partly between a burner in the combustion chamber and a fuel control valve, and a seal positioned at least partly within the opening and having a through hole that is sized and shaped to receive the fuel supply line, the seal comprising a plurality of complementary deformed seal pieces sealed together, to the opening and to the fuel supply line by a deforming force.

We also provide a water heater comprising a water container, a combustion chamber adjacent the water and having an access opening, a burner associated with the combustion chamber and arranged to combust fuel to heat water in the water container, a fuel control valve that regulates fuel flow from an external fuel source, and a door assembly comprising: 1) a base plate sized and shaped to substantially sealingly cover the access opening and having at least one opening through which a fuel supply line extends at least partly between a burner in the combustion chamber and the control valve; and 2) a seal positioned at least partly within the opening and having a through hole that is sized and shaped to receive the fuel supply line, the seal comprising a plurality of complementary deformed seal pieces sealed together, to the opening and to the fuel supply line by a deforming force.

We further provide a method of producing a water heater door assembly comprising providing a base plate sized and shaped to substantially sealingly cover an access opening in a water heater combustion chamber and having at least one opening through which a fuel supply line extends at least partly between a burner in the combustion chamber and a fuel control valve, assembling a plurality of complementary seal pieces in the opening, passing the fuel supply line through a through hole formed by the complementary seal pieces and applying force to the complementary seal pieces sufficient to deform the seal pieces to substantially seal the seal pieces together, to the opening and to the fuel supply line.

### BRIEF DESCRIPTION OF THE DRAWINGS

FIG. 1 is a schematic front elevational view of a water heater.

FIG. 2 is a schematic side elevational view of the water heater of FIG. 1.

FIG. 3 is a schematic front elevational view, taken partly in section, of the lower portion of a water heater of the type shown in FIGS. 1 and 2.

FIG. 4 is a schematic perspective view, partially cut away, of the lower portion of the water heater.

FIG. 5 is a schematic perspective view of a pair of complementary fittings.

FIG. 6 is a schematic perspective view of another pair of complementary fittings.

FIG. 7 is a schematic perspective view of yet another shape of a complementary fitting.

FIG. 8 is a schematic perspective view of a combustion chamber door having a portion of a fuel line extending through a through hole in the door and being held in place by a pair of complementary fittings.

FIG. 9 is a schematic sectional view of the structure of FIG. 8 subsequent to application of deformation force to the complementary fittings.

FIG. 10 is a schematic perspective view of the exterior of a combustion chamber door showing a fuel line extending therethrough and being sealed into place.

FIG. 11 is a perspective view of the structure shown in FIG. 10 from the opposite side of the door.

### DETAILED DESCRIPTION

It will be appreciated that the following description is intended to refer to specific aspects of the representative structures selected for illustration in the drawings and is not intended to define or limit the substance of this disclosure, other than in the appended claims.

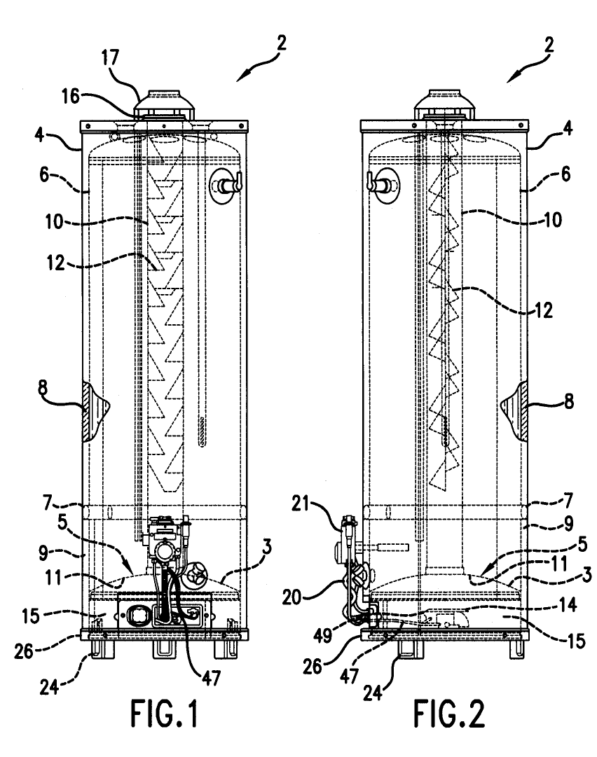

Turning now to the drawings in general and FIGS. 1-4 in particular, the number “2” designates a storage type gas water heater 2. Water heater 2 includes jacket 4 which surrounds a water tank 6 and a main burner 14 in a combustion chamber 15. The term “water tank” or “water container” can include conventional storage type water tanks. However, it can include other types of structures through which water passes and/or is retained for a period of time whether extended or just momentary. Thus, the water tank or container can also be as simple a structure as a pipe or conduit through which water flows.

Passing through the center of the tank 6 is a flue 10, in this instance incorporating a series of baffles 12 to better transfer heat generated by the main burner 14. Water tank 6 is preferably of mains pressure capability and is capable of holding heated water. Water tank 6 is preferably insulated by foam insulation 8. Alternative insulation may include fiberglass or other types of fibrous insulation, heating retaining material and the like. Fiberglass insulation 9 surrounds combustion chamber 15 and the lowermost portion of water tank 6. It is possible that heat resistant foam insulation can be used if desired. A foam dam 7 separates foam insulation 8 and fiberglass insulation 9.

Located underneath the water tank 6, within the combustion chamber 15, is the main burner 14 which uses any type of fuel such as oil, natural gas or other gases such as LPG, for example. Other suitable fuels may be substituted. Fuel is provided to the main burner 14 through the fuel supply line 20, which is fluidly connected to fuel control valve 21. Fuel control valve 21 supplies fuel to burner 14 by way of fuel supply line 20. Main burner 14 combusts a fuel and air mixture and the hot products of combustion resulting rise up through flue 10, possibly with heated air. Water tank 6 is lined with a glass or other type of coating for corrosion resistance. Bottom 5 of water tank 6 is preferably coated on both its interior facing surface 3 and exterior facing surface 11. The thickness of the coating of exterior facing surface 11 may be about half of the thickness of interior facing surface 3. Also, the lower portion of flue 10 is preferably coated on both of its opposing surfaces. The surface exposed to the flue gases has a thickness about half the thickness of the surface exposed to water in water tank 6. The glass coating helps to prevent scaling of the flue and water tank surfaces.

Combustion chamber 15 also contains a pilot burner 49 connected to fuel control valve 21 by pilot fuel supply line 47. A sheath 52, preferably made of copper, contains wires (not shown) from a flame detecting thermocouple 51 to cause, in the absence of a flame at pilot burner 49, fuel control valve 21 to shut off the gas supply. Thermocouple 51 may be selected from those known in the art. RobertShaw Model No. TS 750U may be used, for example.

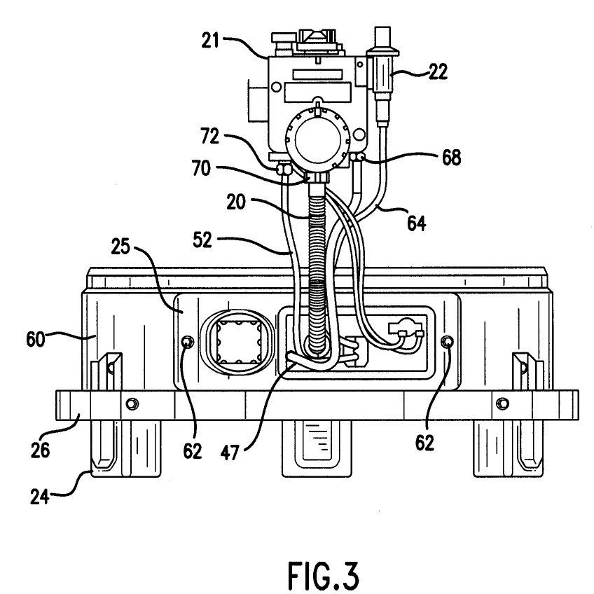

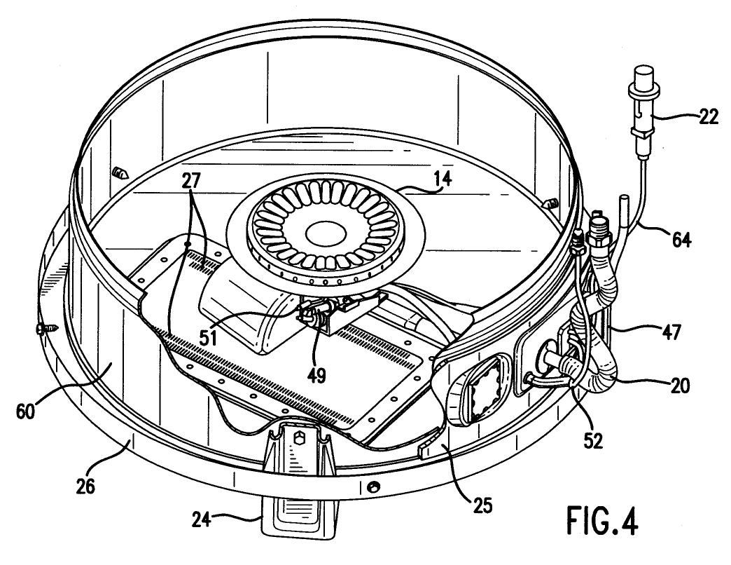

FIGS. 3 and 4 particularly show fuel supply line 20 and pilot fuel supply line 47 extending outwardly from a door 25, which provides access to the combustion chamber 15. Door 25 is removably sealable to skirt 60 that forms the side wall of combustion chamber 15. Door 25 is held into position by a pair of screws 62 or by any other suitable means. Pilot fuel supply line 47 and fuel supply line 20 pass through door 25 in a substantially fixed and sealed condition. Sheath 52 also extends through door 25 in a substantially fixed and sealed condition as does igniter line 64. Igniter line 64 connects on one end to an igniter button 22 and a piezo igniter. Igniter button 22 can be obtained from Channel Products, for example. Each of pilot fuel supply line 47, fuel supply line 20 and sheath 52 are removably connectable to fuel control valve 21 by compression nuts 68, 70 and 72, respectively. Each of compression nut 68, 70 and 72 are threaded and threadingly engage control valve 21. Other means of connecting may be employed as alternatives.

The products of combustion pass upwardly and out the top of jacket 4 via flue outlet 16 after heat has been transferred from the products of combustion. The flue outlet 16 discharges conventionally into a draft diverter 17 which in turn connects to an exhaust duct leading outdoors.

Water heater 2 is preferably mounted on legs 24 to raise bottom pan 26 off the floor. Bottom pan 26 preferably has one or more apertures 27 or some other means that receive combustion air. Where bottom pan 26 meets jacket 4, the mating surfaces (made up from surfaces of bottom pan 26 and jacket 4) can be sealed thoroughly to prevent ingress of air or any flammable gas or vapor. The cylindrical wall of jacket 4 (the majority of gas water heaters are cylindrical; however, a cubic or other shaped jacket 4 may be utilized) can be sealed substantially gas tightly so that no openings or breaks remain upon assembly and installation.

In particular, gas, water, electrical, control or other connections, fittings or plumbing, wherever they pass through the jacket 4 or bottom pan 26 may be sealed substantially airtightly. The joining area of bottom pan 26 to jacket 4 and service entries or exits to the jacket 4 need not be sealed airtightly. It is preferred, however, that the space around burner 14 be substantially air/gas tight except for means to supply combustion air.

Turning now to FIG. 5, a pair of complementary fittings 100 are shown in a perspective view and oriented apart from one another, but substantially positioned to be aligned adjacent to each other. Each fitting 100 comprises a substantially semi-circular barrel portion 102 and a substantially semi-circular flange 104. The barrel portion is sized and shaped so that it approximately fits through a through hole in door 25 with just enough clearance so that distal end 106 of barrel portion 102 extends through the through hole and the outer surface of door 25 substantially contacts a surface of flange 104. Flange 104 accordingly extends radially outwardly from barrel portion 102 in a substantially perpendicular direction.

In the two structures shown in FIG. 5, a flange of one of the fittings has two ribs 108 that extend outwardly from that flange. Similarly, the complementary fitting has a flange with a pair of grooves 110 that are substantially sized and shaped to receive the ribs 108 from the opposed, complementary flange.

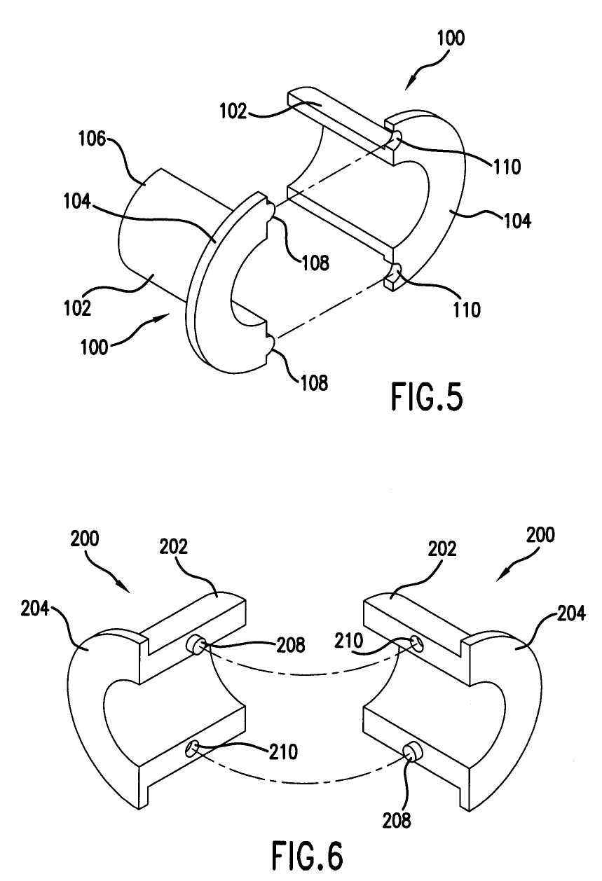

FIG. 6 shows another type of a pair of complementary fittings 200. They contain similar barrel portions 202 relative to the barrel portions 102 of fittings 100. Fittings 200 also have flanges 204 that are similar to flanges 104 of fittings 100 as shown in FIG. 5.

Fittings 200 each have a substantially cylindrically-shaped protrusion 208 that extends from the barrels 202. Then, each fitting 200 on the opposed face of barrels 202 has a substantially cylindrically-shaped bore 210 that is sized and shaped to receive in a close fit the protrusions 208 from a complementary fitting 200.

It should be noted in the structure of FIG. 6, that the protrusions and bores are oriented on the barrels 202 of the fittings 200 as opposed to being located on the flanges 104 of the fittings 100 of FIG. 5. The location of the various ribs, grooves, protrusions and bores may be on various portions of the fittings so long as they are effective to serve as a means of aligning the respective fittings with respect to one another.

FIG. 7 shows yet another structure of a fitting 300. It also has a barrel 302 and a flange 304 similar to the barrels and flanges of the structures of FIGS. 5 and 6. The difference between fitting 300 and the fittings 100 of FIG. 5 is that instead of having the ribs 108 located on a single fitting and the complementary grooves 110 located on the other complementary fitting, the grooves 310 of FIG. 7 are located on different fittings as opposed to the same fitting 300. Similarly, the ribs 308 are located on one of each of the two fittings 300 as opposed to both ribs 308 being located on the same fitting 308.

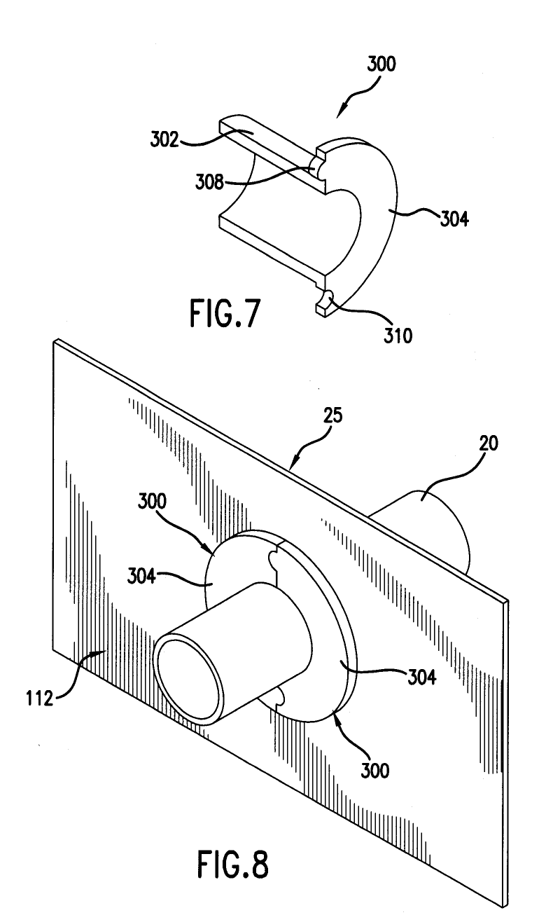

FIG. 8 shows a perspective view of a door 25 in a simplistic, flattened form for ease of understanding. Fuel supply line 20 extends through a through hole in door 25. A pair of complementary fittings 300 also extend through the through hole such that barrels 302 extend through the thickness of door 25 and one of the surfaces of each of flanges 304 is substantially positioned against exterior surface 112 of door 25. Ribs 308 from each of the complementary fittings 300 closely engages grooves 310, so that the pair of complementary fittings 300 are closely aligned with one another.

The arrangement in FIG. 8 allows for the exterior surface of the barrels 302 to be sized and shaped slightly smaller than the diameter of the through hole to allow sufficient room for both the fittings 300 and fuel supply line 20 to pass through the through hole. The inner diameter of the barrels 302 is also sized and shaped to closely receive the exterior surface of fuel supply line 20. It should be noted that the structure shown in FIG. 8 is such that the complementary fittings 300 and fuel supply line 20 are all positioned together and within the through hole of door 25 such that a deforming force may be applied to the complementary fittings 300. Such deforming force is applied to the flanges 304 of each fitting 300 at the exterior surface 112 of door 25 on the one hand and are applied to the exterior surface of barrel portions of fittings 300 from the interior surface of door 25.

The amount of deforming force may be varied depending on the material that is used to manufacture the fittings 100, 200 and 300. Also, any number of different devices may be used to apply the deforming force. Any number of materials can be used so long as they are heat resistant, deform in response to deforming force and are capable of providing a seal between fuel supply line 20 and door 25. Aluminum is a particularly preferred material. Of course, various aluminum alloys may be used as may be other metals such as copper, copper alloys, and mild steel. Non-metals may also be used such as, for example, silicon rubber.

The assembly may be made by inserting the two complementary fittings 300 into the through hole with fuel supply line 20 having been inserted inside the complementary fittings. Then, the fittings are subjected to deforming force from both inside and outside of the door in the axial direction along the center line of fuel supply line 20. The material used to form fittings 300 deforms or “flows” radially inwardly and outwardly. Inward flow affixes the material of the complementary fittings to fuel supply line 20, while outward flow affixes the material of the complementary fittings to the through hole of the door. This achieves complete attachment of the fuel line to the door and also results in a substantially airtight seal.

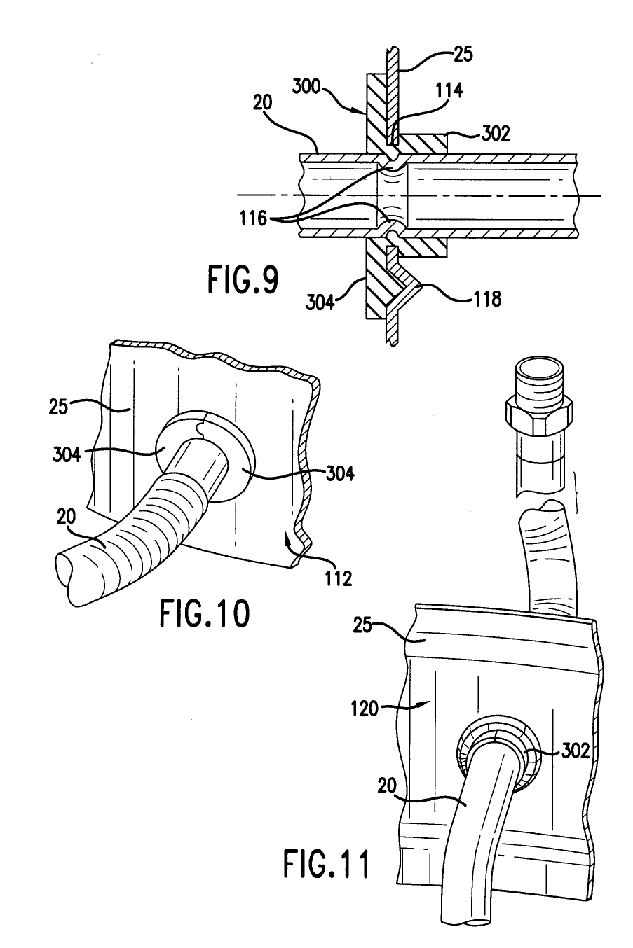

The resulting deformed structure is shown in FIG. 9. FIG. 9 is a sectional view of door 25 having been provided with a pair of complementary fittings 300 and fuel supply line 20. The complementary fittings 300 have been subjected to deforming force. Such deforming force results in “flow” of material from the fittings 300 into spaces between the edge 114 of the through hole to achieve a tight seal. Thus, the groove 116 provided in fuel supply line 20 is filled with “flowed” material from fittings 300. Similarly, the groove 118 provided in door 25 is also filled with “flowed” material from complementary fittings 300. This helps to ensure the stability of the fit between the fuel line and the door on the one hand and also assists in creating a substantially airtight seal.

FIG. 10 shows fuel supply line 20 affixed to door assembly 25 substantially in the same manner as indicated in FIG. 9. FIG. 10 shows the exterior surface 112 of door 25 and flanges 304. FIG. 11 shows an interior surface 120 of door 25 and the deformed portions of barrels 302.

It will be understood that water heater 2 may be constructed with a wide variety of materials, in a wide variety of shapes and sizes. For example, any number of types of burners 14 may be employed, along with various types of fuel control valves 21 and the like. Also, various types of insulation, water containers/tanks and jackets may be employed.

Although the contents of this disclosure have been described in connection with specific representative forms thereof, it will be appreciated that a wide variety of equivalents may be substituted for the specified elements described herein without departing from the spirit and scope of this disclosure as described in the appended claims.

What is claimed is:

1. A water heater door assembly comprising:
a base plate sized and shaped to substantially sealingly cover an access opening in a water heater combustion chamber and having at least one opening through which a fuel supply line extends at least partly between a burner in the combustion chamber and a fuel control valve; and
a seal positioned at least partly within the opening and having a through hole that is sized and shaped to receive the fuel supply line, the seal comprising a plurality of complementary deformed seal pieces sealed together, to the opening and to the fuel supply line by a deforming force.

2. The door assembly of claim 1, wherein the plurality of complementary deformed seal pieces comprise a pair of complementary, substantially semi-circular fittings that each comprise a half-barrel portion that extends through the opening and a flange portion extending substantially perpendicular, radially outwardly from the half-barrel portion.

3. The door assembly of claim 2, wherein the fittings are made from aluminum.

4. The door assembly of claim 2, wherein the fittings further comprise:
at least one male or female portion sized and shaped to sealingly engage a male or female portion on an adjacent fitting.

5. The door assembly of claim 1, wherein the seal further comprises an opening sized and shaped to sealingly receive a pilot fuel supply line.

6. The door assembly of claim 1, wherein the seal further comprises an opening sized and shaped to sealingly receive at least one electrical wire.

7. A water heater comprising:
a water container;
a combustion chamber adjacent the water and having an access opening;
a burner associated with the combustion chamber and arranged to combust fuel to heat water in the water container;
a fuel control valve that regulates fuel flow from an external fuel source; and
a door assembly comprising: 1) a base plate sized and shaped to substantially sealingly cover an access opening and having at least one opening through which a fuel supply line extends at least partly between a burner in the combustion chamber and the control valve; and 2) a seal positioned at least partly within the opening and having a through hole that is sized and shaped to receive the fuel supply line, the seal comprising a plurality of complementary deformed seal pieces sealed together, to the opening and to the fuel supply line by a deforming force.

8. The water heater of claim 7, wherein the plurality of complementary deformed seal pieces comprise a pair of complementary, substantially semi-circular fittings that each comprise a half-barrel portion that extends through the opening and a flange portion extending substantially perpendicular, radially outwardly from the half-barrel portion.

9. The water heater of claim 8, wherein the fittings are made from aluminum.

10. The water heater of claim 8, wherein the fittings further comprise:
at least one male or female portion sized and shaped to sealingly engage a male or female portion on an adjacent fitting.

11. The water heater of claim 7, wherein the fuel supply line has an indentation formed in its surface and a portion of the seal is deformed into the indentation.

12. The water heater of claim 7, wherein the base plate has an indentation formed in its surface adjacent the opening and a portion of the seal is deformed into the indentation.

13. The water heater of claim 7, wherein the flexible seal is formed from silicon based material.

14. A method of producing a water heater door assembly comprising:
providing a base plate sized and shaped to substantially sealingly cover an access opening in a water heater combustion chamber and having at least one opening through which a fuel supply line extends at least partly between a burner in the combustion chamber and a gas control valve;
assembling a plurality of complementary seal pieces in the opening;
passing the fuel supply line through a through hole formed by the complementary seal pieces; and
applying force to the complementary seal pieces sufficient to deform the seal pieces that substantially seals the seal pieces together, to the opening and to the fuel supply line.

15. The water heater door assembly of claim 14, wherein the seal pieces are aluminum.

16. The water heater door assembly of claim 14, wherein the deforming force causes the seal pieces to deform into an indentation formed in the surface of the fuel supply line.

17. The water heater door assembly of claim 14, wherein the deforming force causes the seal pieces to deform into an indentation formed in the surface of the base plate.
